(19) United States
(12) Patent Application Publication
(10) Pub. No.: US 2004/0200834 A1
(43) Pub. Date: Oct. 14, 2004

(54) Covered refuse container

(76) Inventor: Warren Evanko, Glen Gardner, NJ (US)

Correspondence Address: Mr. Walter J. Tencza Jr., Suite 3, 10 Station Place, Metuchen, NJ, 08840, US

(21) Appl. No.: 10/862,293

(22) Filed: Jun. 7, 2004

(51) Int. Cl. A01G 25/00

(52) U.S. Cl. 220/200

(57) ABSTRACT

An apparatus is disclosed including a refuse container and a plant-like enclosure into which the refuse container is placed so that the refuse container is substantially covered by the plant-like enclosure. The plant-like enclosure may include one or more leaves. The plant-like enclosure may include one or more vines. A method is further disclosed including enclosing a refuse container in a plant-like enclosure.

### FIELD OF THE INVENTION

This invention relates to improved methods and apparatus concerning providing aesthetically pleasing refuse containers.

### BACKGROUND OF THE INVENTION

Typically in the prior art refuse containers or garbage cans are provided in a standard simplistic manner.

### SUMMARY OF THE INVENTION

The present invention in one or more embodiments provides an apparatus comprising a refuse container and a plant-like enclosure into which the refuse container is placed so that the refuse container is substantially covered by the plant-like enclosure. The plant-like enclosure may include one or more leaves. The plant-like enclosure may include one or more vines. A method is further disclosed including enclosing a refuse container in a plant-like enclosure.

### BRIEF DESCRIPTION OF THE DRAWINGS

FIG. 1 shows a front view of an apparatus in accordance with an embodiment of the present invention; and

FIG. 2 shows a top view of the apparatus of FIG. 1.

### DETAILED DESCRIPTION OF THE DRAWINGS

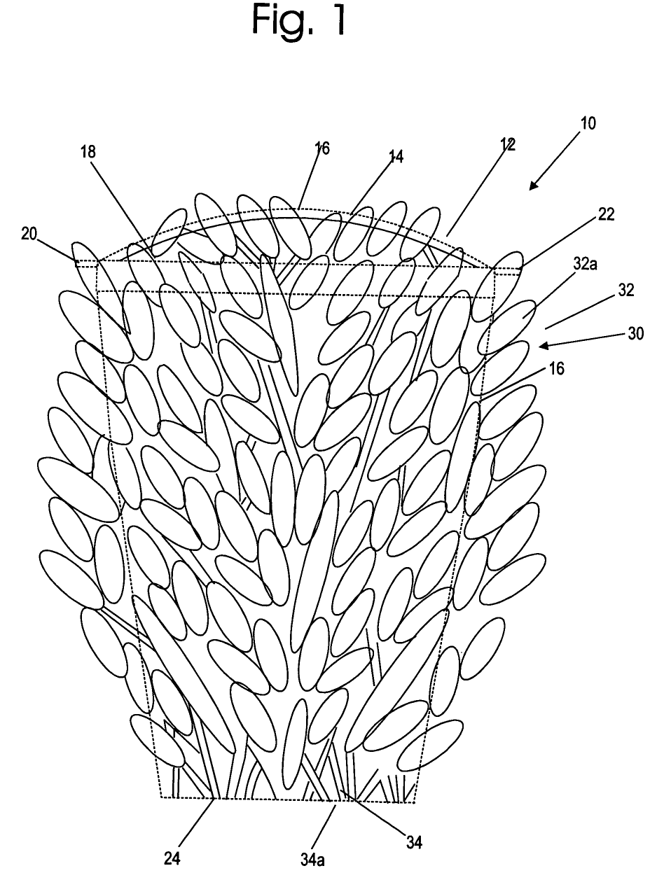

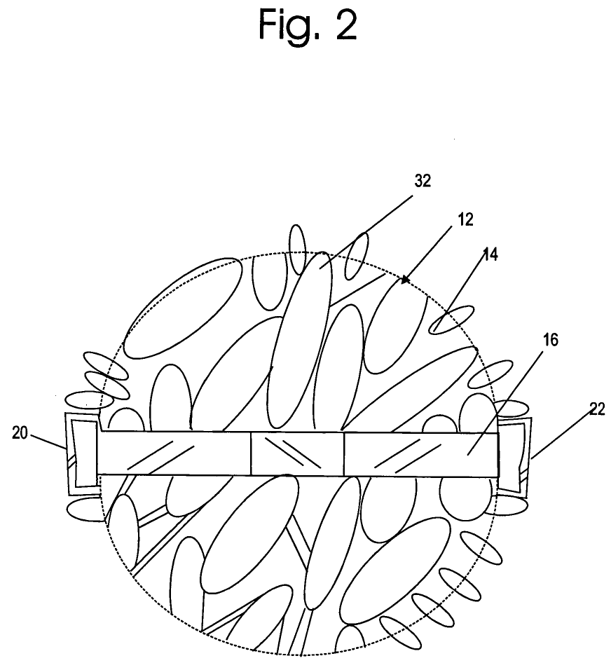

FIG. 1 shows a front view of an apparatus 10 in accordance with an embodiment of the present invention. FIG. 2 shows a top view of the apparatus 10 of FIG. 1.

The apparatus 10 is comprised of typical garbage or refuse container 12 encompassed within a plant structure 30. The plant structure 30 may have the appearance of a shrub or bush or any other kind of plant.

The container 12 includes a lid 14 comprised of a top rail or handle 16 located on a top surface 18. The container 12 includes a body portion 16, which may have a cylindrical shape and a closed bottom surface 24. The lid 14 is connected to handles 20 and 22. The handles 20 and 22 may have the appearance of branches. The lid 14 can be removed to reveal an opening, not shown, in the top 21 of the body portion 16 to allow garbage to be thrown into the body portion 16.

The plant structure 30 may include a plurality of leaves 32 such as leaf 32a. The plant structure 30 may also include a plurality of roots or vines 34, such as root or vine 34a.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a refuse container; and
a plant-like enclosure into which the refuse container is placed so that the refuse container is substantially covered by the plant-like enclosure.

2. The apparatus of claim 1 wherein
the plant-like enclosure includes one or more leaves.

3. The apparatus of claim 1 wherein
the plant-like enclosure includes one or more vines.

4. A method comprising the steps of:
enclosing a refuse container in a plant-like enclosure.

5. The method of claim 4 wherein
the plant-like enclosure includes one or more leaves.

6. The method of claim 4 wherein
the plant-like enclosure includes one or more vines.
